(19) United States
(12) Patent Application Publication
(10) Pub. No.: US 2011/0089914 A1
(43) Pub. Date: Apr. 21, 2011

(54) Apparatus and method for isolating an adaptive voltage scaling (AVS) loop in a powered system

(75) Inventor: Mark Hartman, Santa Clara, CA (US)

(73) Assignee: National Semiconductor Corporation, Santa Clara, CA (US)

(21) Appl. No.: 12/587,910

(22) Filed: Oct. 15, 2009

(51) Int. Cl. G05F 1/10

(52) U.S. Cl. 323/234

(57) ABSTRACT

A method includes generating a regulated voltage for a powered component and modifying the regulated voltage with an adaptive voltage scaling (AVS) control loop. The method also includes further modifying the regulated voltage using at least one additional control loop. The AVS control loop is isolated from the at least one additional control loop. Modifying the regulated voltage with the AVS control loop could include storing an AVS digital value and converting the AVS digital value into an analog signal. Modifying the regulated voltage with the AVS control loop could also include modifying a control signal for a voltage regulator using the analog signal, where the voltage regulator generates the regulated voltage. Modifying the regulated voltage with the AVS control loop could further include buffering the analog signal and outputting the buffered analog signal as an isolated AVS signal over the AVS control loop.

### TECHNICAL FIELD

This disclosure is generally directed to power supply systems. More specifically, this disclosure is directed to an apparatus and method for isolating an adaptive voltage scaling (AVS) loop in a powered system.

### BACKGROUND

Many systems use adaptive voltage scaling (AVS) loops to control the supply of power to components of the systems. An example AVS loop may include multiple delay cells coupled in series, where the speed of the delay cells varies based on a supply voltage. A signal can be sent through the delay cells, and the supply voltage can be adjusted until the signal reaches a first one of the delay cells and not a second one of the delay cells. In this way, the AVS loop can help to estimate the supply voltage necessary to achieve a desired level of performance. Many systems also include load line regulation, which adjusts the supply voltage provided to components of a system as a function of an output current.

### BRIEF DESCRIPTION OF THE DRAWINGS

For a more complete understanding of this disclosure and its features, reference is now made to the following description, taken in conjunction with the accompanying drawings, in which:

FIG. 1 illustrates a first example powered system having an isolated adaptive voltage scaling (AVS) loop according to this disclosure;

FIG. 2 illustrates a second example powered system having an isolated AVS loop according to this disclosure; and

FIG. 3 illustrates an example method for powering a system using an isolated AVS loop according to this disclosure.

### DETAILED DESCRIPTION

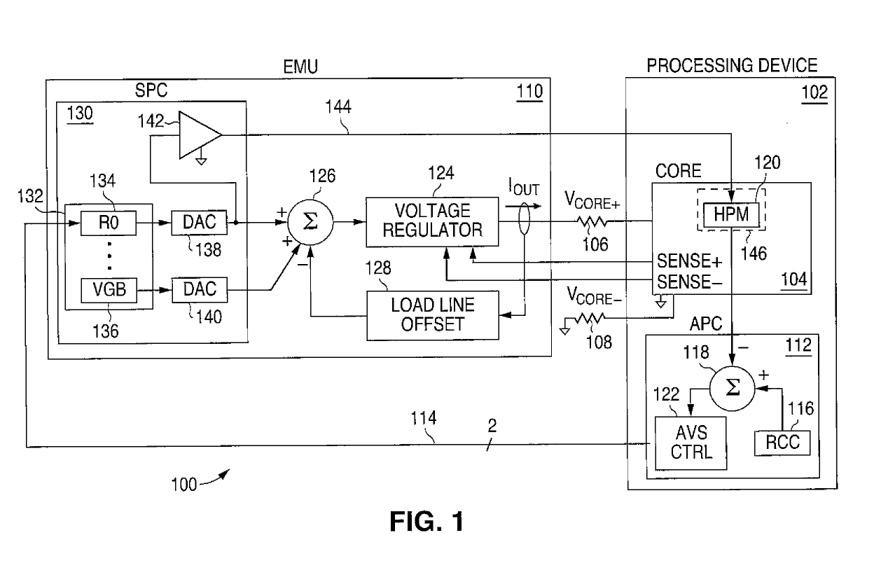

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIG. 1 illustrates a first example powered system 100 having an isolated adaptive voltage scaling (AVS) loop according to this disclosure. The embodiment of the powered system 100 shown in FIG. 1 is for illustration only. Other embodiments of the powered system 100 could be used without departing from the scope of this disclosure.

As shown in FIG. 1, the powered system 100 includes a processing device 102 that is being powered. The processing device 102 could represent any suitable processing component, such as a microprocessor, microcontroller, digital signal processor, or application specific integrated circuit. Note that a processing device represents only one example type of component that could be powered in a powered system using an isolated AVS loop. Any other or additional type(s) of powered component(s) could be used in the powered system 100.

In this example, the processing device 102 includes a processing core 104, which generally denotes the portion of the processing device 102 responsible for executing instructions and performing other processing operations. The processing core 104 receives a supply voltage V_{CORE+}-V_{CORE-} from an energy management unit (EMU) 110. The supply voltage can provide high currents, including current I_{OUT}, that develop across two resistors 106-108 in FIG. 1. The resistors 106-108 represent small parasitic resistances found, for example, in routing, socket, and processor power grids.

The processing device 102 also includes an advanced power controller (APC) 112. The APC 112 performs operations to generate an output signal 114, which is used to adjust the voltage provided to the processing device 102. In this example, the APC 112 includes a reference calibration code (RCC) table 116, which acts as a digital reference for the AVS loop. The APC 112 also includes a summer 118, which subtracts an output of a hardware performance monitor (HPM) 120 from the appropriate digital reference retrieved from the RCC table 116. The APC 112 further includes an AVS control unit 122, which uses the output of the summer 118 to generate the output signal 114.

The RCC table 116 includes any suitable structure for storing and retrieving calibration codes to act as a reference for an AVS loop. The summer 118 includes any suitable structure for combining values. The AVS control unit 122 includes any suitable structure for compensating an AVS loop and outputting voltage commands (analog or digital). Details of example advanced power controllers implementing AVS technology can be found in the following U.S. patents, all of which are hereby incorporated by reference: U.S. Pat. No. 7,581,131; U.S. Pat. No. 7,581,120; U.S. Pat. No. 7,493,149; U.S. Pat. No. 7,479,768; U.S. Pat. No. 7,289,921; U.S. Pat. No. 7,117,378; U.S. Pat. No. 7,106,040; U.S. Pat. No. 7,024,568; U.S. Pat. No. 6,985,025; U.S. Pat. No. 6,944,780; U.S. Pat. No. 6,868,503; and U.S. Pat. No. 6,548,991.

The HPM 120 monitors the operation of the processing core 104. For example, the HPM 120 could measure the propagation delay of digital operations in the processing core 104, such as by using a series of delay cells. The propagation delay could vary based on a number of factors, such as process, voltage, and temperature (PVT) variations. The HPM 120 outputs a performance code to the advanced power controller 112, where the performance code identifies the operation of the processing core 104. The performance code could, for example, represent a measure of the propagation delay in the processing core 104. The HPM 120 includes any suitable structure for monitoring the operation of a powered device. Details of example hardware performance monitors can be found in various ones of the U.S. patents incorporated by reference above.

In the example shown in FIG. 1, the EMU 110 includes a voltage regulator 124 that generates the output voltage V_{CORE+}. The voltage regulator 124 can also adjust the output voltage V_{CORE+} provided to the processing device 102. The voltage regulator 124 can use various input signals to generate and control the output voltage V_{core+}. These input signals can include positive and negative sense currents received from the processing core 104. The input signals could also include an output produced by a summer 126, the operation of which is described below. The voltage regulator 124 includes any suitable structure for generating a regulated output voltage.

The summer 126 receives various input signals. One input signal comes from a load line offset unit 128, which monitors the output current I_{OUT} and generates an offset signal that can modulate the output voltage V_{core+} based on the output current I_{OUT}. The load line offset unit 128 includes any suitable structure for generating an offset signal for modifying an output voltage based on an output current.

The summer 126 also receives input signals from a slave power controller (SPC) 130. The SPC 130 receives the output signal 114 from the APC 112 and uses the output signal 114 to provide multiple signals to the summer 126. In this example, the SPC 130 includes a register bank 132, which stores various data values related to power control. The register bank 132 includes a voltage register 134, which stores the value of the output signal 114 received from the APC 112, such as a two-bit value. The voltage register 134 could, for example, denote a PWI voltage register as defined by the POWERWISE INTERFACE standard from NATIONAL SEMICONDUCTOR CORPORATION.

The register bank 132 also includes one or more voltage guard band registers 136, which can be used to store data values defining voltage guard bands. The voltage guard bands represent additional margin that can be added to the voltage defined by the AVS system, where the guard bands are added via a separate reference input contained in the EMU 110. The guard bands could be static (such as based on characterization of a circuit) or dynamic (such as based on a function of a dynamic parameter like I_{OUT}). The register bank 132 includes any suitable structure for storing and retrieving data values related to power control.

As shown in FIG. 1, the SPC 130 also includes two digital-to-analog converters (DACs) 138-140. The DAC 138 receives the digital value from the voltage register 134 and converts the digital value into a corresponding analog value. The DAC 140 similarly receives the digital value(s) from the guard band register(s) 136 and converts the digital value(s) into a corresponding analog value(s). Each of the DACs 138-140 includes any suitable structure for converting a digital value into a corresponding analog value.

In this example, the analog outputs of the DACs 138-140 are added together by the summer 126, thereby providing the guard band(s) to the AVS voltage. Also, the load line offset is subtracted by the summer 126, thereby providing load line compensation.

The powered system 100 shown in FIG. 1 includes at least two control loops. One control loop is the load line loop that includes the voltage regulator 124, the summer 126, and the load line offset unit 128. Another control loop is the AVS loop that includes the HPM 120, the APC 112, and the SPC 110. A third control loop (not shown) could be a regulation loop for controlling the output voltage.

Ideally, the load line offset and the guard bands are rejected by the AVS system, such as by filtering, in order to provide the minimum voltage margin for proper operation. In other words, the load line offset and the guard bands need to be ignored by the AVS system. Otherwise, the AVS loop will attempt to trim out the load line and guard band offsets.

In accordance with this disclosure, the output from the DAC 138 is provided to a buffer 142, which buffers the DAC output to produce a signal 144. The signal 144 is then provided to the HPM 120. The signal 144 here represents only the analog version of the value stored in the voltage register 134, meaning it represents only the AVS control information. The signal 144 does not include any of the load line offset or guard band control information. As a particular example, the summer 126 could output a voltage of approximately 1V, while the buffer 142 could output a 700 mV or 800 mV signal that represents the AVS portion of the 1V signal.

This architecture therefore provides very good isolation of the load line offset from the HPM 120. Since the HPM 120 acts as the sensor for the AVS control loop, the AVS loop also has good load line cancellation or isolation. As a result, the AVS loop may operate only as a function of the PVT or other variations that the HPM 120 detects and can regulate these disturbances with no interaction from the load line regulation loop.

In some embodiments, the HPM 120 resides within an electrically isolated voltage island 146 within the processing device 102. The input from the EMU 110 represents a buffered AVS voltage for the HPM 120 in the voltage island 146. The ground of the voltage island 146 could be tied to the low-current return path SENSE-, rather than to the power ground (which carries high current). By isolating HPM 120 from the core voltage, the entire AVS loop can ignore the effects of the guard band voltage. This can provide the ability to deconstruct the core voltage into well-controlled portions and to sum them back together to supply the core. The core voltage can be thought of as V_{CORE}=V_{AVS}+V_{GB(static)}+V_{GB(dynamic)}, where V_{CORE} denotes the core voltage, V_{AVS} denotes the voltage defined by the AVS system, and V_{GB(static)} and V_{GB(dynamic)} denote the static and dynamic guard bands. In particular embodiments, V_{AVS}, V_{GB(static)} and V_{GB(dynamic)} could each have its own input with reference to a power supply so that each can be independently set and controlled by the EMU 110.

One potential advantage of the architecture shown in FIG. 1 is that the core voltage can be a function of many dynamic and static inputs. Some conventional AVS architectures may require that the entire core voltage be set by one reference, which means that the fixed and dynamic guard bands are often built into the reference. Additional guard bands may be needed in the reference if the HPM 120 is unable to accurately measure absolute quantities such as voltage. The architecture in FIG. 1 may allow the AVS loop to regulate timing delay versus PVT variations using the HPM 120, and the guard bands (either fixed or dynamic) can be independently regulated by a power supply that employs a very accurate voltage reference. In this way, few or no extra guard bands are needed to account for variations in the HPM 120.

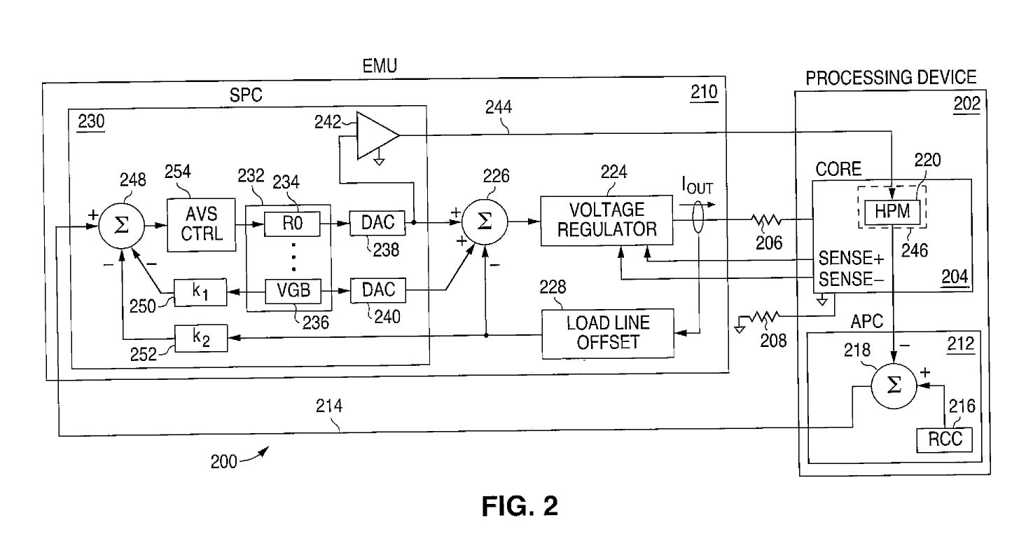

FIG. 2 illustrates a second example powered system 200 having an isolated AVS loop according to this disclosure. The embodiment of the powered system 200 shown in FIG. 2 is for illustration only. Other embodiments of the powered system 200 could be used without departing from the scope of this disclosure.

In this example, the powered system 200 includes a processing device 202 or other powered component. The processing device 202 includes a processing core 204 that receives a supply voltage from an EMU 210, and high currents are produced across parasitic resistances 206-208. The processing device 202 also includes an APC 212 that produces an output signal 214. The APC 212 includes an RCC table 216 and a summer 218 coupled to an HPM 220. The EMU 210 includes a voltage regulator 224, a summer 226, a load line offset unit 228, and an SPC 230. The SPC 230 includes a register bank 232 with a voltage register 234 and one or more voltage guard band registers 236. The SPC 230 also includes two DACs 238-240 and a buffer 242 that produces a signal 244. Many of these components 202-244 may be the same as or similar to the corresponding components 102-144 in FIG. 1. The HPM 220 in FIG. 2 may or may not reside within an electrically isolated voltage island 246 within the processing device 202.

In this example, the signal 214 output by the APC 212 is an error signal, which represents the difference between the output of the HPM 220 and the output of the RCC table 216. The error signal 214 here includes errors associated with the AVS system, the load line offset, and the guard bands. A summer 248 combines the error signal 214 from the APC 212 with feedback signals from two gain units 250-252, which are used to remove the load line offset and guard band errors from the signal 214.

The gain unit 250 applies a gain to the contents of the guard band register(s) 236, and the gain unit 252 applies a gain to the offset signal from the load line offset unit 228. The gains help to convert the values of the guard band register(s) and the load line offset in terms of voltage into their equivalent values in terms of HPM output (timing delay). The summer 248 subtracts the outputs of the gain units 250-252 from the signal 214 to produce an output that generally represents only the error associated with the AVS control loop. The output of the summer 248 is provided to an AVS control unit 254, which uses the AVS error to produce an AVS output signal provided to the voltage register 234.

The specific gains provided by the gain units 250-252 could be determined in any suitable manner. For example, the gains could be static or dynamic. Dynamic gains could be based on various factors, such as the temperature of the processing device 202 as provided by a temperature sensor in the device 202. The gains could be calibrated at startup or during operation.

Although FIGS. 1 and 2 illustrate examples of powered systems 100 and 200 having isolated AVS loops, various changes may be made to FIGS. 1 and 2. For example, a powered system could be used to provide operating power to any suitable powered component(s). Also, an AVS loop could be isolated from any suitable number of control loops in a powered system.

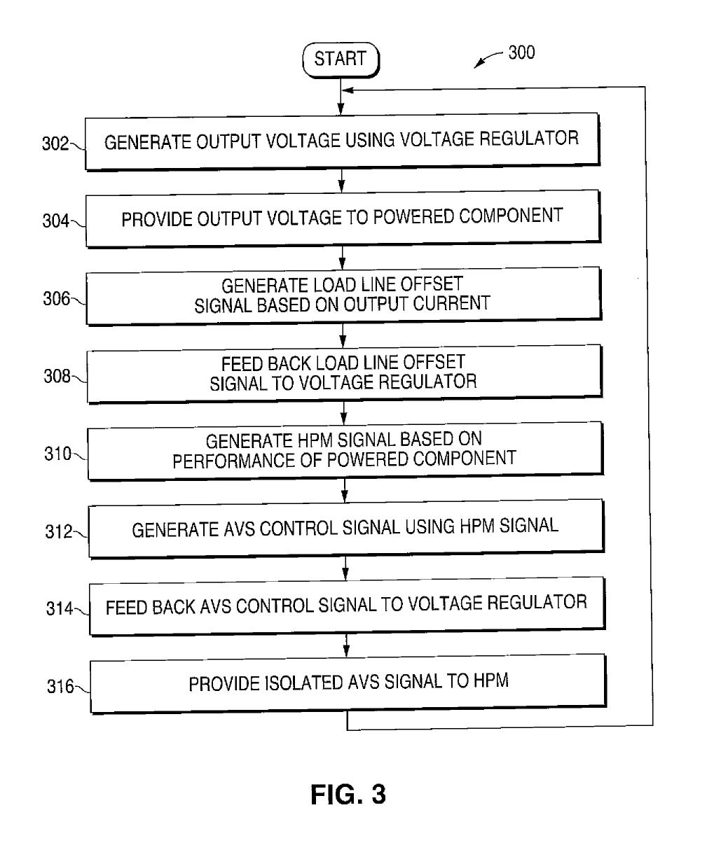

FIG. 3 illustrates an example method 300 for powering a system using an isolated AVS loop according to this disclosure. The embodiment of the method 300 shown in FIG. 3 is for illustration only. Other embodiments of the method 300 could be used without departing from the scope of this disclosure.

As shown in FIG. 3, an output voltage is generated using a voltage regulator at step 302. This could include, for example, generating the output voltage V_{CORE+} using the voltage regulator 124, 224. The voltage regulator could generate the output voltage V_{CORE+} based on input signals received from the summer 126, 226, as well as sense feedback signals from a powered component. The output voltage is provided to the powered component at step 304.

A load line offset signal based on an output current is generated at step 306. This could include, for example, providing a feedback signal based on the output current I_{OUT} (or a copy of the output current I_{OUT} or a scaled version thereof) to the load line offset unit 128, 228. The offset signal is fed back to the voltage regulator at step 308. This could include, for example, providing the offset signal to the summer 126, 226, which combines the offset signal with other signals (including an AVS signal) and provides a result to the voltage regulator 124, 224.

An HPM signal is generated based on the performance of the powered component at step 310. This could include, for example, the HPM 120, 220 generating a performance code representing a measure of the propagation delay in the powered component. An AVS signal is generated using the HPM signal at step 312. This could include, for example, providing the HPM signal to a summer 118, 218 that combines the HPM signal with an output from the RCC table 116, 216. This could also include the AVS control unit 122 using the output of the summer 118 to produce the AVS signal. This could further include the summer 248 combining the output of the summer 218 with voltages received from the gain units 250-252 and providing the result to the AVS control unit 254, which generates the AVS signal. The AVS signal is fed back to the voltage regulator at step 314. This could include, for example, providing the AVS signal to the summer 126, 226, which combines the AVS signal with other signals (including the load line offset signal) and provides a result to the voltage regulator 124, 224.

An isolated AVS signal is provided to the HPM at step 316. This could include, for example, a buffer 142, 144 providing a buffered version of the analog signal from the DAC 138, 238 to the HPM 120, 220. The isolated AVS signal may represent only the AVS component of the output signal produced by the summer 126, 226. The isolated AVS signal may not include any component related to load line isolation and guard band control.

Although FIG. 3 illustrates one example of a method 300 for powering a system using an isolated AVS loop, various changes may be made to FIG. 3. For example, while shown as a series of steps, various steps in FIG. 3 could overlap, occur in parallel, occur in a different order, or occur multiple times. As a particular example, the voltage regulator may continuously operate to produce the output voltage at steps 302-304. In parallel, the load line offset could be produced and fed back to the voltage regulator at steps 306-308 for use in generating the output voltage. Also in parallel, the AVS signal could be produced and fed back to the voltage regulator for use in generating the output voltage and the isolated AVS signal can be sent to the HPM at steps 310-316.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a voltage regulator configured to generate a regulated voltage for a powered component;
at least one control loop configured to adjust the regulated voltage; and
a power controller configured to provide an adaptive voltage scaling (AVS) signal to an AVS control loop, the AVS control loop also configured to adjust the regulated voltage, the AVS control loop isolated from the at least one control loop.

2. The apparatus of claim 1, wherein the power controller comprises:
a register configured to store a digital value from a second power controller;
a digital-to-analog converter configured to convert the digital value into an analog signal; and
a buffer configured to buffer the analog signal and to output the buffered analog signal as the AVS signal.

3. The apparatus of claim 2, wherein the power controller is configured to provide the AVS signal to a hardware performance monitor (HPM) in the powered component, the digital value from the second power controller based on an output of the HPM.

4. The apparatus of claim 1, wherein the power controller comprises:
a summer configured to modify an error signal from the powered component using feedback from the at least one control loop;
an AVS control unit configured to generate a digital value based on an output of the summer;
a register configured to store the digital value;
a digital-to-analog converter configured to convert the digital value into an analog signal; and
a buffer configured to buffer the analog signal and to output the buffered analog signal as the AVS signal.

5. The apparatus of claim 4, wherein:
the at least one control loop comprises a load line offset control loop; and
the summer is configured to modify the error signal by removing a first portion associated with a voltage guard band and a second portion associated with a load line offset.

6. The apparatus of claim 1, wherein:
the power controller comprises:
a first digital-to-analog converter configured to convert an AVS digital value into a first analog signal; and
a second digital-to-analog converter configured to convert a voltage guard band digital value into a second analog signal; and
the apparatus further comprises a summer configured to combine the first and second analog signals.

7. The apparatus of claim 6, wherein:
the at least one control loop comprises a load line offset control loop; and
the summer is further configured to remove a load line offset from the first and second analog signals.

8. A system comprising:
a powered component; and
an energy management unit (EMU) configured to generate a regulated voltage for the powered component, the EMU comprising (i) at least one control loop configured to adjust the regulated voltage and (ii) a portion of an adaptive voltage scaling (AVS) control loop also configured to adjust the regulated voltage, the AVS control loop isolated from the at least one control loop.

9. The system of claim 8, wherein the EMU comprises:
a voltage regulator configured to generate the regulated voltage; and
a power controller in the portion of the AVS control loop.

10. The system of claim 9, wherein the power controller comprises:
a register configured to store a digital value from a second power controller;
a digital-to-analog converter configured to convert the digital value into an analog signal; and
a buffer configured to buffer the analog signal and to output the buffered analog signal as an AVS signal over the AVS control loop.

11. The system of claim 10, wherein the power controller is configured to provide the AVS signal to a hardware performance monitor (HPM) in the powered component, the digital value from the second power controller based on an output of the HPM.

12. The system of claim 11, wherein the HPM is located in an electrically isolated voltage island in the powered component.

13. The system of claim 9, wherein the power controller comprises:
a summer configured to modify an error signal from the powered component using feedback from the at least one control loop;
an AVS control unit configured to generate a digital value based on an output of the summer;
a register configured to store the digital value;
a digital-to-analog converter configured to convert the digital value into an analog signal; and
a buffer configured to buffer the analog signal and to output the buffered analog signal as an AVS signal over the AVS control loop.

14. The system of claim 13, wherein:
the at least one control loop comprises a load line offset control loop; and
the summer is configured to modify the error signal by removing a first portion associated with a voltage guard band and a second portion associated with a load line offset.

15. The system of claim 9, wherein:
the power controller comprises:
a first digital-to-analog converter configured to convert an AVS digital value into a first analog signal; and
a second digital-to-analog converter configured to convert a voltage guard band digital value into a second analog signal; and
the EMU further comprises a summer configured to combine the first and second analog signals.

16. The system of claim 15, wherein:
the at least one control loop comprises a load line offset control loop; and
the summer is further configured to remove a load line offset from the first and second analog signals.

17. The system of claim 8, wherein the powered component comprises a processor.

18. A method comprising:
generating a regulated voltage for a powered component;
modifying the regulated voltage with an adaptive voltage scaling (AVS) control loop; and
further modifying the regulated voltage using at least one additional control loop, wherein the AVS control loop is isolated from the at least one additional control loop.

19. The method of claim 18, wherein modifying the regulated voltage with the AVS control loop comprises:
storing an AVS digital value;
converting the AVS digital value into an analog signal;
modifying a control signal for a voltage regulator using the analog signal, the voltage regulator generating the regulated voltage; and
buffering the analog signal and outputting the buffered analog signal as an isolated AVS signal over the AVS control loop.

20. The method of claim 19, wherein outputting the buffered analog signal as the isolated AVS signal comprises providing the isolated AVS signal to a hardware performance monitor (HPM) in the powered component, the HPM residing in an electrically isolated voltage island in the powered component.
